(19) United States
(12) Patent Application Publication
(10) Pub. No.: US 2021/0057898 A1
(43) Pub. Date: Feb. 25, 2021

(54) TRANSMISSION LINE VIBRATION REDUCTION DEVICE BASED ON EDDY CURRENT ENERGY CONSUMPTION TECHNOLOGY

(71) Applicant: DALIAN UNIVERSITY OF TECHNOLOGY, Dalian, Liaoning (CN)

(72) Inventors: Xing FU, Dalian, Liaoning (CN); Hongnan LI, Dalian, Liaoning (CN); Wenlong DU, Dalian, Liaoning (CN)

(21) Appl. No.: 16/762,065

(22) PCT Filed: May 23, 2019
(86) PCT No.: PCT/CN2019/088124

§ 371 Date: May 6, 2020

(51) Int. Cl. H02G 7/14; F16F 15/03

(52) U.S. Cl. CPC H02G 7/14; F16F 15/035

(57) ABSTRACT

A transmission line vibration reduction device based on an eddy current energy consumption technology is provided, which can effectively reduce the vibration in the direction perpendicular to a transmission line, that is, the vibration in the direction of the most unfavorable load of a transmission tower structure under normal conditions, and can effectively improve the bearing capacity of a line iron tower; can greatly improve the energy consumption efficiency by carrying out energy consumption using an eddy current technology and by adjusting the gear radius ratio, and can effectively reduce the vibration of the transmission line; can realize the adjustment of damping parameters by adjusting the magnetic field intensity of permanent magnets and the distance between a copper sheet and each permanent magnet; can generate a long-term stable vibration reduction effect by using the permanent magnets to provide continuous magnetic field sources without outside energy.

### TECHNICAL FIELD

The present invention relates to the technical field of power equipment and transmission line vibration reduction, and particularly to a transmission line vibration reduction device based on an eddy current energy consumption technology.

### BACKGROUND

With the gradual increase of the demand for electricity in many countries and regions in the world, the span of transmission lines and the bundle number of conductor are increasing, which leads to the increasingly serious wind vibration damage of transmission lines. The vibration of transmission lines under wind load cannot be ignored, which may cause damage such as, line breaking, fatigue strand broking, etc. in severe cases, thus greatly threatening the safe operation of the transmission lines. In order to reduce the damage to the transmission lines caused by conductor vibration, effective measures must be taken to suppress the vibration. At present, the usual method is to install devices such as damping spacer, detuning pendulum, damping spacer, etc. to achieve the purpose of suppressing the conductor vibration. However, the vibration reduction effect is limited. Therefore, the development of a vibration reduction device with the advantages of reasonable design and obvious vibration reduction effect may be beneficial to the safe operation of transmission lines and reduce maintenance costs.

### SUMMARY

The purpose of the present invention is to provide a transmission line vibration reduction device based on an eddy current energy consumption technology.

The technical solution of the present invention is:

A transmission line vibration reduction device based on an eddy current energy consumption technology, comprising an insulator string 1, a slider 2, a guide bar 3, a wire spring 4, a gear a 5, a connecting rod a 6, a gear b 7, a gear c 8, a connecting rod b 9, a copper sheet 10, permanent magnets 11, a steel plate 12, bolts 13, a cover plate 14, a hollow body 15, balls 16 and a slide hole 17,

wherein a shell of the entire vibration reduction device is formed by the hollow body 15 and the cover plate 14, and the two are connected by the bolts 13; the entire vibration reduction device is composed of two energy consumption units which are symmetrically arranged; and the two energy consumption units share the insulator string 1 and the slider 2, and are symmetrical left and right;

the insulator string 1 passes through the slide hole 17 at the bottom center of the hollow body 15, with the upper end thereof is connected to the slider 2, and the lower end is connected to a conductor;

the slide hole 17 is provided at the bottom of the hollow body 15 in the direction of movement of the slider 2, and has a size equal to the stroke of the slider 2;

the slider 2 is sleeved on the guide bar 3, the side surface of the slider 2 is provided with teeth, the slider 2 is not in direct contact with the shell of the device, and the balls 16 are used to conduct friction reduction treatment;

the guide bar 3 is fixed to the shell by two ends, guides the displacement of the slider 2, and is sleeved thereon with the wire spring 4; one end of the wire spring 4 is connected to the shell, and the other end thereof is connected to the slider 2;

the gear a 5 is engaged with the teeth of the side surface of the slider 2, and the gear b 7 is engaged with the gear c 8; the gear a 5 and the gear b 7 are rigidly connected to the connecting rod a 6 respectively, and the gear c 8 is rigidly connected to the connecting rod b 9;

a closed cavity is formed by the steel plate 12 and the shell, the permanent magnets 11 and the copper sheet 10 are placed in the closed cavity, the two permanent magnets 11 are fixed at the top and the bottom of the closed cavity respectively, and the copper sheet 10 is located between the two permanent magnets 11;

the connecting rod b 9 passes through the closed cavity and passes through the permanent magnet 11, the copper sheet 10 and the permanent magnet 11 in sequence, is not in direct contact with the shell by the two ends thereof, and uses the balls 16 to conduct friction reduction treatment; and the copper sheet 10 is rigidly connected to the connecting rod b 9.

The radius of the gear b 7 is greater than that of the gear c 8.

The balls 16 are spherical steel balls.

The slider 2, the guide bar 3, the wire spring 4, the gear a 5, the connecting rod a 6, the gear b 7, the gear c 8, the connecting rod b 9, the steel plate 12, the bolts 13, the cover plate 14, the hollow body 15 and the balls 16 are all made of a magnetic material.

The present invention has the operating principle that: when the transmission conductor vibrates in the direction perpendicular to the transmission line, the insulator string drives the slider to move, and then drives the gear a, the gear b, the gear c and the copper sheet to rotate. According to the Lenz's law, the copper sheet may be subjected to a force that suppresses the movement thereof. This is because the relative movement between the copper sheet and the magnetic field causes a dynamic electromotive force to be generated in the copper sheet, and electric charges move to form eddy currents. These eddy currents are subjected to a Lorentz force under the action of the magnetic field, and the direction is always opposite to the direction of movement of the copper sheet, thereby forming resistance, that is, eddy current damping force. At the same time, due to the thermal effect of the current, a part of vibration energy may be converted into thermal energy, thereby reducing vibration. In particular, assuming that the slide distance of the slider is d, the radius of the gear a is Rₐ, the radius of the gear b is R_{b}, the radius of the gear c is R_{c}, and R_{b}>R_{c}, the rotation angle of the copper sheet can be amplified, wherein the rotation angle is (d/Rₐ)*(R_{b}/R_{c}), and the amplification is R_{b}/R_{c}, that is, the larger the radius ratio of the gear b to the gear c, the smaller the radius of the gear a, the higher the energy consumption efficiency.

The present invention has the following advantageous effects that:

(1) The transmission line vibration reduction device based on an eddy current energy consumption technology of the present invention can effectively reduce the vibration in the direction perpendicular to a transmission line, that is, the vibration in the direction of the most unfavorable load of a transmission tower structure under normal conditions, and can effectively improve the bearing capacity of a line iron tower;

(2) The transmission line vibration reduction device based on an eddy current energy consumption technology of the present invention can greatly improve the energy consumption efficiency by carrying out energy consumption using an eddy current technology and by adjusting the gear radius ratio, and can effectively reduce the vibration of the transmission line;

(3) The transmission line vibration reduction device based on an eddy current energy consumption technology of the present invention can realize the adjustment of damping parameters by adjusting the magnetic field intensity of permanent magnets and the distance between a copper sheet and each permanent magnet;

(4) The transmission line vibration reduction device based on an eddy current energy consumption technology of the present invention can generate a long-term stable vibration reduction effect by using the permanent magnets to provide continuous magnetic field sources without outside energy;

(5) The transmission line vibration reduction device based on an eddy current energy consumption technology of the present invention can effectively avoid the magnetic flux leakage of the magnetic circuit by using the magnetic material, so that not only the efficiency of eddy current damping is improved, but also the influence on various components on the periphery is avoided;

(6) The transmission line vibration reduction device based on an eddy current energy consumption technology of the present invention is reasonable in design, simple in structure, and convenient in installation and maintenance.

### DESCRIPTION OF DRAWINGS

FIG. 1 is an A-A sectional view of a transmission line vibration reduction device based on an eddy current energy consumption technology provided in embodiments of the present invention;

FIG. 2 is B-B sectional view of a transmission line vibration reduction device based on an eddy current energy consumption technology provided in embodiments of the present invention; and

FIG. 3 is a location diagram of a transmission line vibration reduction device based on an eddy current energy consumption technology provided in embodiments of the present invention.

In the figures, 1. insulator string; 2. slider; 3. guide bar; 4. wire spring; 5. gear a; 6. connecting rod a; 7. gear b; 8. gear c; 9. connecting rod b; 10. copper sheet; 11. permanent magnet; 12. steel plate; 13. bolt; 14. cover plate; 15. hollow body; 16. ball; 17. slide hole.

### DETAILED DESCRIPTION

To make a purpose, characteristics and advantages of the present invention more clear and legible, the technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

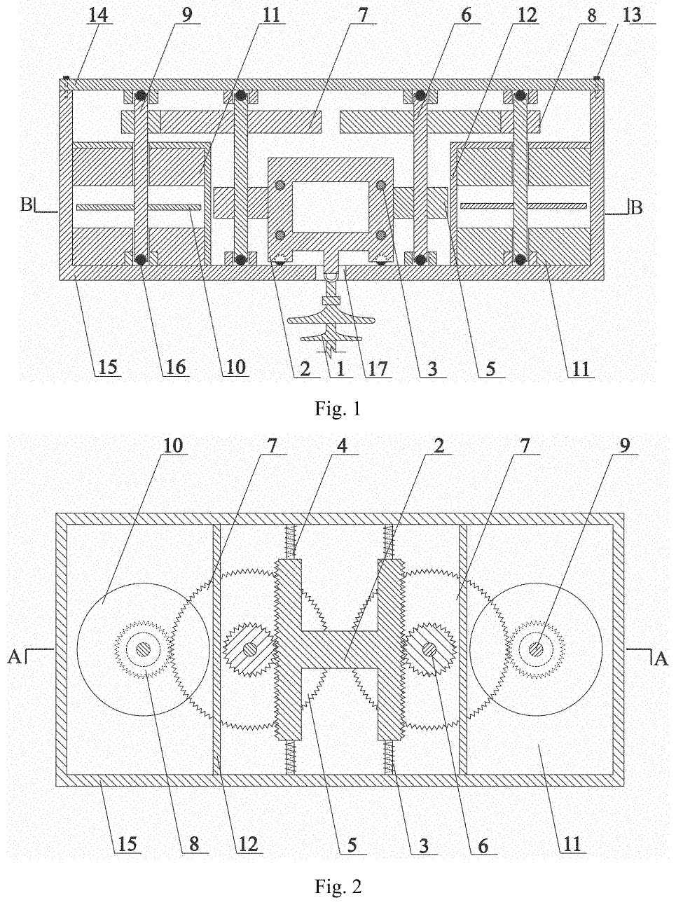

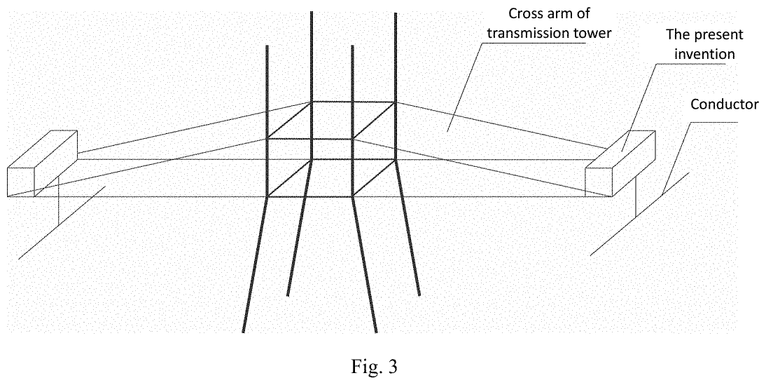

Referring to FIG. 1 to FIG. 3, an embodiment of a transmission line vibration reduction device based on an eddy current energy consumption technology provided in embodiments of the present invention comprises an insulator string 1, a slider 2, a guide bar 3, a wire spring 4, a gear a 5, a connecting rod a 6, a gear b 7, a gear c 8, a connecting rod b 9, a copper sheet 10, permanent magnets 11, a steel plate 12, bolts 13, a cover plate 14, a hollow body 15, balls 16 and a slide hole 17,

wherein a conductor is suspended on the insulator string 1, and the insulator string 1 is connected to the slider 2; when the conductor vibrates under the action of wind, the insulator string 1 and the slider 2 are driven to shift in the direction of the guide bar 3, and the slider 2 is reset under the action of the wire spring 4 after the vibration; the teeth of the side surface of the slider 2 are engaged with the gear a 5, the movement of the slider 2 drives the gear a 5 to rotate, the gear b 7 is rigidly connected to the connecting rod a 6, and thus the gear a 5 and the gear b 7 rotate synchronously; the gear b 7 is engaged with the gear c 8, and the rotation of the gear b 7 drives the gear c 8 to rotate; the copper sheet 10 is rigidly connected to the connecting rod b 9, and thus the copper sheet 10 and the gear c 8 rotate synchronously; the copper sheet 10 rotates between the magnetic fields generated by the two permanent magnets 11 to generate eddy currents, and the radius of the gear b 7 is greater than that of the gear c 8, so the rotation angle of the copper sheet 10 can be amplified, thereby generating eddy currents with higher intensity and improving the damping efficiency; the steel plate 12 is wrapped around the permanent magnets 11 and forms a closed cavity together with the shell of the device, thereby guaranteeing the magnetic permeability and improving the eddy current generation efficiency; the balls 16 are mounted at the positions where the connecting rods and the slider 2 are in contact with the shell, so that friction can be reduced; and the shell of the entire device is formed by the hollow body 15 and the cover plate 14, and the two are connected by the bolts 13 to facilitate disassembling and assembling.

The transmission line vibration reduction device based on an eddy current energy consumption technology of the present invention can effectively reduce the vibration in the direction perpendicular to a transmission line, that is, the vibration in the direction of the most unfavorable load of a transmission tower structure under normal conditions, and can effectively improve the bearing capacity of a line iron tower; can greatly improve the energy consumption efficiency by carrying out energy consumption using an eddy current technology and by adjusting the gear radius ratio, and can effectively reduce the vibration of the transmission line; can realize the adjustment of damping parameters by adjusting the magnetic field intensity of permanent magnets 11 and the distance between a copper sheet 10 and each permanent magnet 11; can generate a long-term stable vibration reduction effect by using the permanent magnets 11 to provide continuous magnetic field sources without outside energy; can effectively avoid the magnetic flux leakage of the magnetic circuit by using the magnetic material, so that not only the efficiency of eddy current damping is improved, but also the influence on various components on the periphery is avoided; and is reasonable in design, simple in structure, and convenient in installation and maintenance. Because the transmission line is almost subjected to a wind load at any time, and earthquakes rarely occur, the application of the eddy current energy consumption spacer to wind resistance of the transmission line is more important.

Attention should be paid when designing the present invention: firstly, the present invention can only reduce the vibration in the direction perpendicular to the transmission line, but has no vibration reduction effect in the longitudinal direction of the transmission line, however, under normal conditions, the direction of the most unfavorable load of a transmission tower structure is the direction perpendicular to the transmission line, and the bearing capacity of a line iron tower can be effectively improved by controlling the vibration in this direction; secondly, the stiffness of the wire spring 4 needs to be calculated based on the artificially set maximum wind speed, assuming that the wind load at this wind speed is N, the maximum stroke of the slider 17 is L, and the number of springs is in, the minimum stiffness kₘᵢₙ is equal to N/mL, if the stiffness is less than the lower limit value, the slider may easily collide with the shell, which is not beneficial to durability, and if the stiffness is too high, the movement stroke is too small, and the energy consumption efficiency is low; thirdly, the radius R_{b} of the gear b 7 is greater than the radius Rₐ of the gear a 5, so the rotation angle of the copper sheet 10 can be amplified, the amplification being equal to R_{b}/Rₐ; and fourthly, lubricating oil is applied to the gears, the balls 16 and the guide bar 3, to reduce rotation friction.

The above-mentioned embodiments of the present invention are not intended to limit the protection scope of the present invention, and the embodiments of the present invention are not limited thereto. According to the above content of the present invention and in accordance with ordinary technical knowledge and frequently-used means in the art, other various modifications, replacements or alterations can also be made without departing from the basic technical idea of the present invention. These modifications, replacements and alterations are all fallen within the protective scope of the present invention.

1. A transmission line vibration reduction device based on an eddy current energy consumption technology, comprising an insulator string, a slider, a guide bar, a wire spring, a gear a, a connecting rod a, a gear b, a gear c, a connecting rod b, a copper sheet, permanent magnets, a steel plate, bolts, a cover plate, a hollow body, balls and a slide hole,
wherein a shell of the entire vibration reduction device is formed by the hollow body and the cover plate, and the two are connected by the bolts; the entire vibration reduction device is composed of two energy consumption units which are symmetrically arranged; and the two energy consumption units share the insulator string and the slider, and are symmetrical left and right;
the insulator string passes through the slide hole at the bottom center of the hollow body, with the upper end thereof is connected to the slider, and the lower end is connected to a conductor;
the slide hole is provided at the bottom of the hollow body in the direction of movement of the slider, and has a size equal to the stroke of the slider;
the slider is sleeved on the guide bar, the side surface of the slider is provided with teeth, the slider is not in direct contact with the shell of the device, and the balls are used to conduct friction reduction treatment;
the guide bar is fixed to the shell by two ends, guides the displacement of the slider, and is sleeved thereon with the wire spring; one end of the wire spring is connected to the shell, and the other end thereof is connected to the slider;
the gear a is engaged with the teeth of the side surface of the slider, and the gear b is engaged with the gear c; the gear a and the gear b are rigidly connected to the connecting rod a respectively, and the gear c is rigidly connected to the connecting rod b;
a closed cavity is formed by the steel plate and the shell, the permanent magnets and the copper sheet are placed in the closed cavity, the two permanent magnets are fixed at the top and the bottom of the closed cavity respectively, and the copper sheet is located between the two permanent magnets; and
the connecting rod b passes through the closed cavity and passes through the permanent magnet, the copper sheet and the permanent magnet in sequence, is not in direct contact with the shell by the two ends thereof, and uses the balls to conduct friction reduction treatment; and the copper sheet is rigidly connected to the connecting rod b.

2. The transmission line vibration reduction device based on an eddy current energy consumption technology according to claim 1, wherein the radius of the gear b is greater than that of the gear c.

3. The transmission line vibration reduction device based on an eddy current energy consumption technology according to claim 1, wherein the balls are spherical steel balls.

4. The transmission line vibration reduction device based on an eddy current energy consumption technology according to claim 1, wherein the slider, the guide bar, the wire spring, the gear a, the connecting rod a, the gear b, the gear c, the connecting rod b, the steel plate, the bolts, the cover plate, the hollow body and the balls are all made of a magnetic material.

5. The transmission line vibration reduction device based on an eddy current energy consumption technology according to claim 3, wherein the slider, the guide bar, the wire spring, the gear a, the connecting rod a, the gear b, the gear c, the connecting rod b, the steel plate, the bolts, the cover plate, the hollow body and the balls are all made of a magnetic material.
